(19) United States
(12) Patent Application Publication
(10) Pub. No.: US 2010/0117267 A1
(43) Pub. Date: May 13, 2010

(54) PROCESS FOR PELLETIZING PET

(76) Inventors: Henry A. Schworm, Findlay, OH (US); Dennis C. Balduff, Whitehouse, OH (US)

Correspondence Address: FRASER CLEMENS MARTIN & MILLER LLC, 28366 KENSINGTON LANE, PERRYSBURG, OH, 43551, US

(21) Appl. No.: 12/617,225

(22) Filed: Nov. 12, 2009

Related U.S. Application Data
(60) Provisional application No. 61/114,301, filed on Nov. 13, 2008.

(51) Int. Cl. B29B 17/02; B29C 31/08; B29C 71/02

(52) U.S. Cl. 264/344; 425/140; 425/445

(57) ABSTRACT

A pelletizing system and a method for pelletizing a polymer are disclosed. The method comprises the steps of compressing a quantity of polymer flake of a predetermined size to produce a pellet and heating at least one of the polymer flake and the pellet to remove contaminants therefrom.

### CROSS-REFERENCE TO RELATED APPLICATION

This application claims the benefit of U.S. Provisional Patent Application No. 61/114,301 filed on Nov. 13, 2008, hereby incorporated herein by reference in its entirety.

### FIELD OF THE INVENTION

The present invention relates generally to recycling a polymer. More particularly, the invention is directed to a pelletizing system and a method for pelletizing a polymer.

### BACKGROUND OF THE INVENTION

Post-consumer processing of recycled polyethylene terephthalate (RPET) to manufacture a variety of useful consumer products such as flower pots and fence posts is well-known. Typically, the recycling process utilizes used PET containers, such as discarded carbonated beverage containers, which are collected, sorted, washed, and separated from contaminants to yield a relatively clean source of RPET. Additionally, the manufacture of imperfect and damaged molded PET products, particularly the blow molded bottles for use in containing consumer goods, results in a considerable amount of PET waste which the manufacturers of such products would like to reuse. The RPET produced by conventional recycling processes is generally in ground or flake form, which is thereafter melt processed or further pelletized by the end user.

RPET is typically subjected to a grinding operation in order to make the material easier to handle and process. Conventional grinding equipment reduces the RPET to about ⅜ inch particles or flakes. The grinding is conducted in a manner to insure that a consistent flake size will be produced, by employing a grate or screen through which the ground material must pass upon exiting the grinder. Although conventional RPET flakes melt processing and pelletizing equipment is designed to handle ⅜ inch flakes, some RPET materials having sizes as large as ½ inch and as small as ¼ inch are also commercially produced. The bulk density of ⅜ inch flake RPET generally ranges from about 22 to about 35 pounds per cubic foot.

Similarly, RPET and PET pellets are generally formed to a standard, uniform size about 0.12 inch in diameter. The bulk density of such pellets generally ranges from about 50 to about 58 pounds per cubic foot. Typically, PET and RPET melt processing equipment is designed to accept pellets having the above mentioned dimensions and physical characteristics.

The critical aspect for achieving consistently high quality end products utilizing RPET is comprehensive decontamination of the RPET flakes or pellets. Currently, significant decontamination occurs during the washing and sorting of PET scrap. The incoming PET bottles and containers are comminuted to form PET fragments and to remove loose labels, dirt, and other adhered foreign particles. Thereafter, the mixture is air classified and the remaining fragments are washed in a hot detergent solution to remove additional label fragments and adhesives from the PET fragments. The washed PET fragments are then rinsed and placed in a series of flotation baths where heavier and lighter weight foreign particles are removed. The remaining PET fragments are then dried and sold as RPET flakes. Thus, label and basecup glues, polyolefins, PVC, paper, glass, and metals, all of which adversely affect the quality and performance of the finished product, are removed from the RPET.

It would be desirable to develop a pelletizing system and a method for pelletizing a polymer, wherein the polymer is decontaminated to exhibit a residual contaminant level which would make it acceptable for manufacturing new food-grade polymer bottles and containers.

### SUMMARY OF THE INVENTION

Concordant and consistent with the present invention, a pelletizing system and a method for pelletizing a polymer, wherein the polymer is decontaminated to exhibit a residual contaminant level which would make it acceptable for manufacturing new food-grade polymer bottles and containers, has surprisingly been discovered.

In one embodiment, a pelletizing system comprises: a pellet mill for compressing a quantity of polymer flake of a predetermined size to produce a pellet; and a decontamination subsystem for heating at least one of the polymer flake and the pellet to remove contaminants therefrom.

The invention also provides methods for pelletizing a polymer.

One method comprises the steps of: compressing a quantity of polymer flake of a predetermined size to produce a pellet; and heating at least one of the polymer flake and the pellet to remove contaminants therefrom.

Another method comprises the steps of: processing a polymer flake to a powder having a first pre-determined size; compressing a quantity of the powder to produce a plurality of pellets; and heating at least one of the polymer flake, the powder, and the pellets to remove contaminants therefrom.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a pelletizing system according to an embodiment of the present invention;

FIG. 2 is a schematic representation of a size control subsystem of the pelletizing system of FIG. 1;

FIG. 3 is a schematic representation of a mill subsystem of the pelletizing system of FIG. 1;

FIG. 4 is a schematic representation of a decontamination subsystem of the pelletizing system of FIG. 1; and

FIG. 5 is a schematic representation of a material transfer subsystem of the pelletizing system of FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

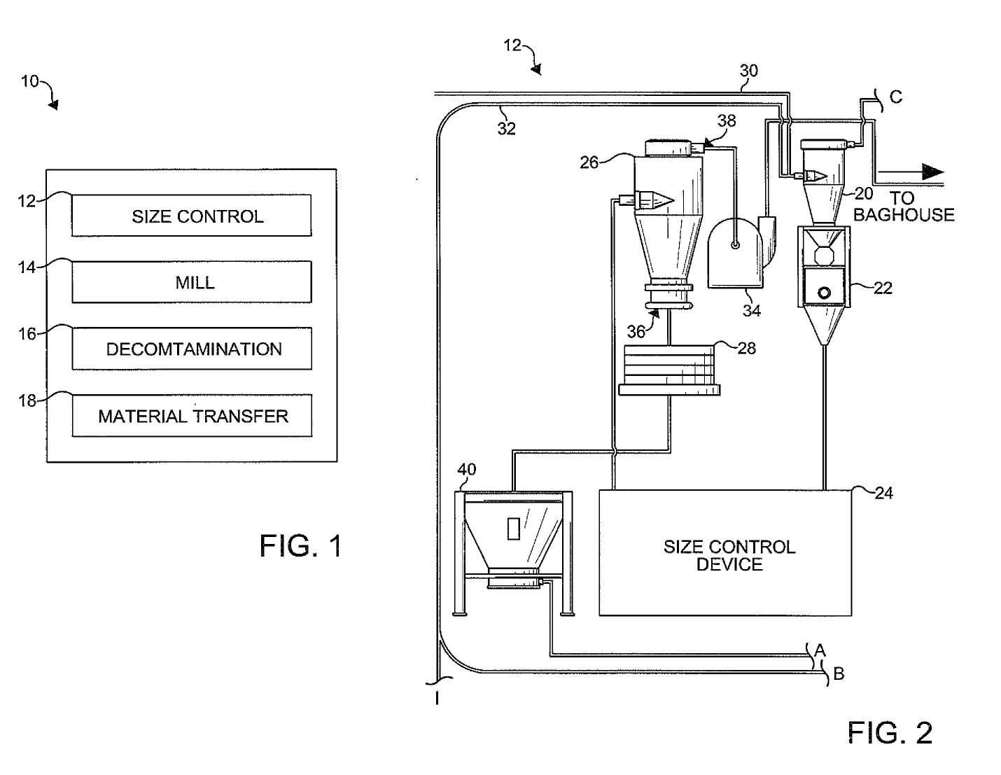

FIGS. 1-5 illustrate a pelletizing system 10 according to an embodiment of the present invention. The pelletizing system 10 includes a size control subsystem 12, a mill subsystem 14, and a decontamination subsystem 16, and a material transfer subsystem 18. It is understood that any number of subsystems may be included.

As more clearly shown in FIG. 2, the size control subsystem 12 includes an infeed loader 20, a first separator 22, a size control device 24, a cyclone 26, and a first screener 28.

The infeed loader 20 receives an infeed stream of a PET material from at least one of a source line 30 and a feedback line 32. In the embodiment shown, the infeed loader 20 is in fluid communication with the material transfer subsystem 18 for dust collection. It is understood that the infeed loader 20 is adapted to receive any size material, flake, or particle therein. As a non-limiting example, the PET material is a PET flake such as a washed bottle flake. As a further example, the source line 30 is adapted to receive the PET material from at least one of a curbside source and a deposit source.

The first separator 22 receives the PET material from the infeed loader 20. The first separator 22 detects and removes a particular contaminant. As a non-limiting example, the first separator 22 detects and removes at least one of a ferrous metal and a non-ferrous metal. It is understood that other contaminates and materials may be detected and removed by the first separator 22.

The size control device 24 receives the PET material from the first separator 22. The size control device 24 processes the PET material to a pre-determined size. As a non-limiting example, the size control device 24 maximizes an area-to-volume ratio and a surface area-to-mass ratio of the PET material as compared to the pre-processed form thereof. As a further example, the size control device 24 processes the PET material into a powder having a size that is less than five hundred microns (ESPS™ powder material) or less than thirty-five Mesh (std. US mesh size). However, the size control device 24 may be adapted to process the PET material to other sizes.

The cyclone 26 receives the processed PET material from the size control device 24 to separate a PET from any contaminants therein. As a non-limiting example, a centrifugal blower 34 creates a centrifugal motion within the cyclone 26 to achieve separation of the PET from a transfer air flow. The PET discharges from a bottom end 36 of the cyclone 26 into the screener 28 for further separation based upon size. The transfer air flow exits the cyclone 26 at a top end 38 and is routed to a collector bin (not shown) or bag house. It is understood that any amount of PET collected in the bag house may be recaptured through the infeed loader 20.

The first screener 28 separates the PET material received from the cyclone 26 based upon a pre-determined size scale. Any PET material having a particular size passes through the first screener 28 and into a surge bin 40. Any material that cannot pass through the first screener 28 is re-fed into the size control device 24 for further processing.

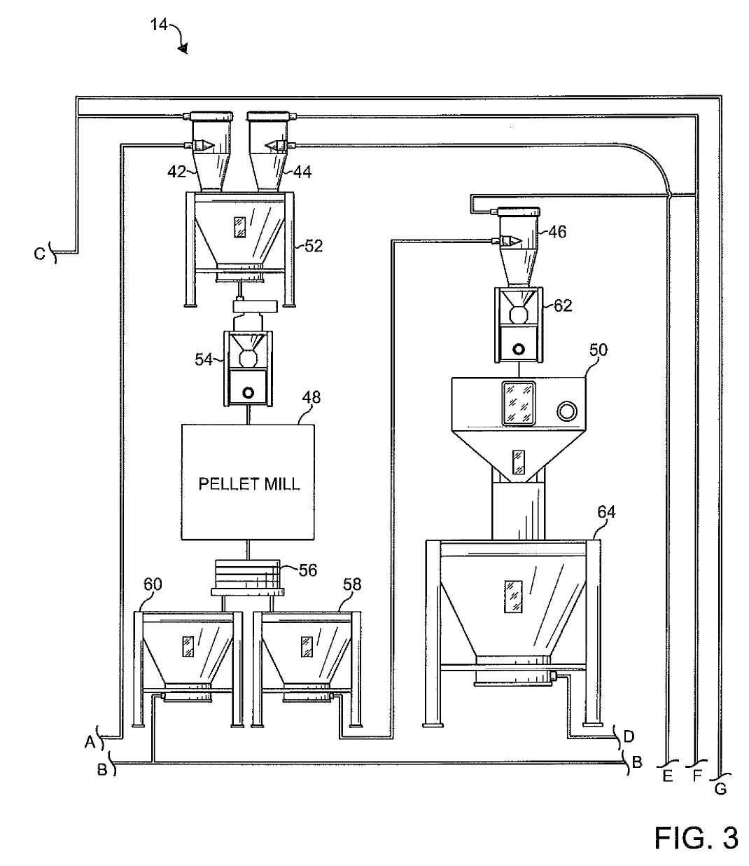

As more clearly shown in FIG. 3, the mill subsystem 14 includes a plurality of mill loaders 42, 44, 46, a pellet mill 48, and a totalizer 50.

A first mill loader 42 receives the PET material from the surge bin 40. A second mill loader 44 receives a PET material from a feedback of the material transfer subsystem 18. In certain embodiments, each of the first mill loader 42 and the second mill loader 44 route any received material into a hopper 52 for distribution into the pellet mill 48. It is understood that any means for feeding material into the pellet mill 48 may be used. As a non-limiting example, a second separator 54 is disposed to detect and remove a particular contaminant in the PET material before entering the pellet mill 48. As a further example, the second separator 54 detects and removes at least one of a ferrous metal and a non-ferrous metal. It is understood that other contaminates and materials may be detected and removed by the second separator 54.

The pellet mill 48 receives and processes the PET material to form a pellet. In certain embodiments, the pellet is a compressed powder with a sintered skin. As a non-limiting example, the pellet mill 48 processes the PET material into a cylindrical shaped pellet. As a further example, the PET material undergoes a decontamination process prior to entering the pellet mill 48.

In the embodiment shown, a second screener 56 is disposed to receive the PET material (e.g. pellets) from the pellet mill 48. The second screener 56 separates the PET material received from the pellet mill 48 based upon a pre-determined size scale. Any PET material having a particular size passes through the second screener 56 and is routed to a third mill loader 46. Any material that cannot pass through the second screener 56 is fed into the infeed loader 20 for further processing.

The third mill loader 46 receives material from at least one of the second screener 56 and the material transfer subsystem 18 and routes the material to the totalizer 50. As a non-limiting example, a third separator 62 is disposed to detect and remove a particular contaminant in the PET material before entering the totalizer 50. As a further example, the third separator 62 detects and removes at least one of a ferrous metal and a non-ferrous metal. It is understood that other contaminates and materials may be detected and removed by the third separator 62.

The totalizer 50 receives the PET material and analyzes the material to provide a characteristic measurement of the material passing therethrough such as a rate of pounds per hour and total pounds of material, for example. In certain embodiments, the totalizer 50 is capable of measuring characteristics of the PET material in real-time such the overall flow of the PET material through the totalizer 50 is not impeded. The PET material passing through the totalizer 50 is collected in a surge bin 64 for distribution control.

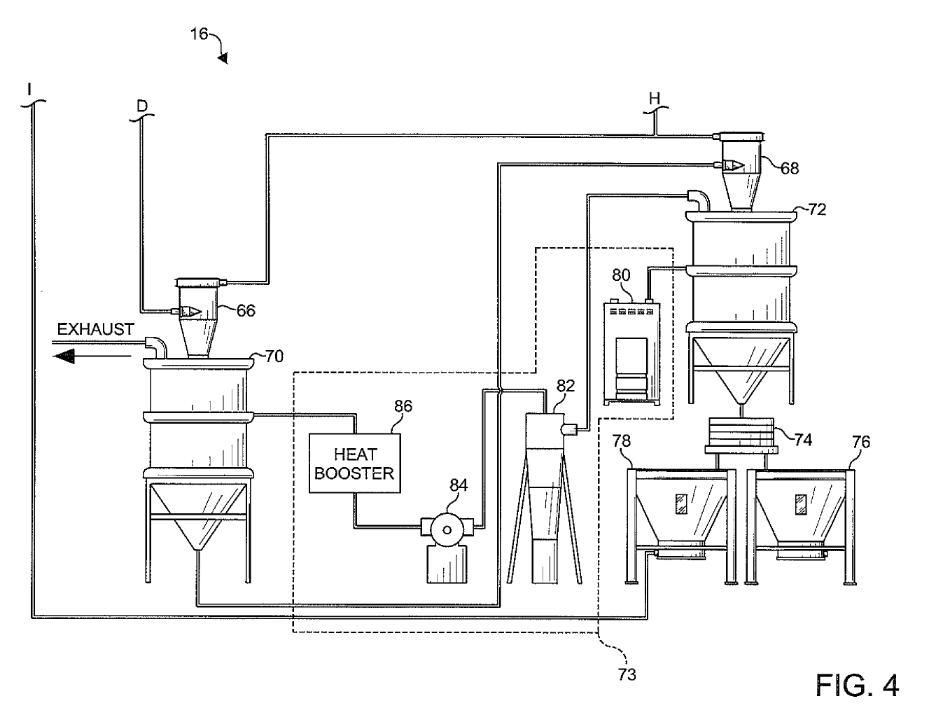

As more clearly shown in FIG. 4, the decontamination subsystem 16 includes a plurality of decontamination loaders 66, 68, a drying hopper 70, a cooling hopper 72, and an air handling system 73.

A first decontamination loader 66 receives the PET material from the surge bin 64 and directs the PET material into the drying hopper 70 for decontamination. In certain embodiments, a heated, desiccated air is supplied to the drying hopper 70 to remove moisture and contaminates from the PET material therein. As a non-limiting example a temperature of the heated air may be adjusted for various threshold requirements such as food grade quality standards. As a further example, a time the heated air is applied to the PET material may be adjusted. It is understood that any means for heating the PET to remove contaminates therefrom may be used.

The cooling hopper 72 receives PET material from the drying hopper 70. A cooled air is applied to the PET material in the cooling hopper 72 to remove a thermal energy therefrom and to regulate a temperature of the PET material to a desired level.

In the embodiment shown, a third screener 74 is disposed to receive the PET material (e.g. pellets) from the cooling hopper 72. The third screener 74 separates the PET material received from the cooling hopper 72 based upon a pre-determined size scale. Any PET material having an acceptable size (e.g. full size pellet) is routed to a pellet surge bin 76 for subsequent use. Any material having an unacceptable size (e.g. pellet tails) passes through the third screener 74 and is routed to a surge bin 78 for further processing through the pelletizing system 10.

The air handling system 73 is an open-loop system that provides the cooled air to the cooling hopper 72 and the heated air to the drying hopper 70. As shown, an intake device 80 draws in an ambient air and conditions the air for application to the PET material. As a non-limiting example, the ambient air is cooled and conditioned to produce a cool, dry fluid flow through the cooling hopper 72. It is understood that the ambient air may be any fluid. After the cooled air is applied to the PET material in the cooling hopper 72, a dry, warm air is exhausted from the cooling hopper 72. Specifically, a thermal energy removed from the PET material in the cooling hopper 72 is used to pre-heat a supply air that is injected into the drying hopper 70. Accordingly, an amount of energy required to decontaminate the PET material in the drying hopper 72 is reduced due to the pre-heating or energy scalping. It is understood that other means for scalping thermal energy from a decontaminated PET material may be used.

In the embodiment shown, a cyclone 82 receives the pre-heated supply air exhausted from the cooling hopper 72 to separate large particles from the air. As a non-limiting example, a centrifugal blower 84 creates a centrifugal motion within the cyclone 82 to achieve separation of any contaminants physically mixed in the air by specific gravity.

The pre-heated supply air is routed through a heat booster 86 to control the temperature of the heated air flowing into the drying hopper 70. It is understood that the “pre-heating step” increases the temperature of the supply air prior to the heat booster 86, thereby minimizing the amount of energy needed to attain a desired temperature of the heated air flowing into the drying hopper 70.

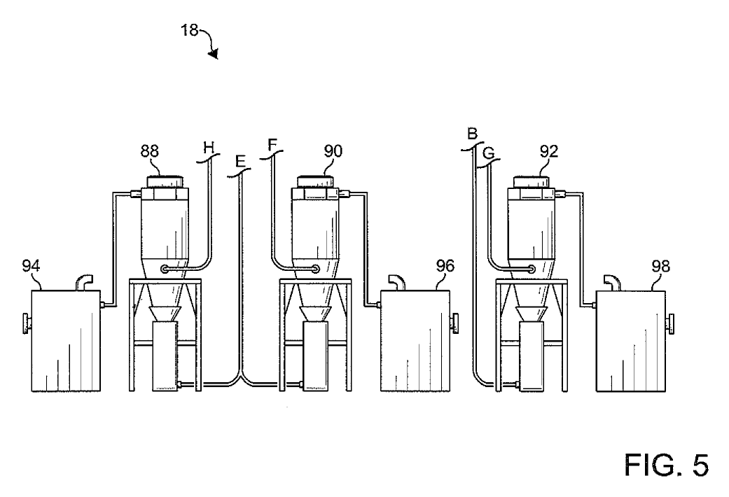

As more clearly shown in FIG. 5, the material transfer subsystem 18 includes a plurality of dust collectors 88, 90, 92, wherein each of the dust collectors 88, 90, 92 is in fluid communication with at least one of a plurality of vacuum pumps 94, 96, 98. The vacuum pumps 94, 96, 98 create an air flow through a plurality of conduits in fluid communication with various loaders and components of the pelletizing system 10. Particles in the air flow are filtered therefrom and re-routed for further processing.

In use, an infeed of PET material is processed to a pre-determined size. The PET material having a pre-determined size is then compressed to produce pellets. For decontamination, the pellets are exposed to a heated air to removed contaminates therefrom. The decontamination of the pellets is designed to take advantage of removing thermal energy from the decontaminated pellet in the cooling hopper 72 in order to pre-heat the air that is injected into the drying hopper 70. The decontamination process also utilizes a unique open-loop design that allows for a heated, desiccated air to flow through the PET material bed the drying hopper 70 and directs a contaminated air for discharge to atmosphere.

Accordingly, the pelletizing system 10 and method of the present invention provides a decontamination of a polymer material to exhibit a residual contaminant level which would make it acceptable for manufacturing new food-grade polymer bottles and containers.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A method for pelletizing a polymer, comprising the steps of:
compressing a quantity of polymer flake of a predetermined size to produce a pellet; and
heating at least one of the polymer flake and the pellet to remove contaminants therefrom.

2. The method according to claim 1, wherein the polymer flake is polyethylene terephthalate.

3. The method according to claim 1, wherein the pellet is porous and has a sintered skin.

4. The method according to claim 1, wherein the polymeric flake has a size less than thirty-five Mesh.

5. The method according to claim 1, wherein at least one of the polymer flake and the pellet is heated by a heated air.

6. The method according to claim 1, further comprising the step of separating a metal from the polymeric flake.

7. The method according to claim 1, wherein at least one of the polymer flake and the pellet is heated with thermal energy removed from a decontaminated pellet.

8. A method for pelletizing a polymer, comprising the steps of:
processing a polymer flake to a powder having a first pre-determined size;
compressing a quantity of the powder to produce a plurality of pellets; and
heating at least one of the polymer flake, the powder, and the pellets to remove contaminants therefrom.

9. The method according to claim 8, wherein the polymer flake is polyethylene terephthalate.

10. The method according to claim 8, wherein the pellet is porous and has a sintered skin.

11. The method according to claim 8, wherein the powder has a size less than thirty-five Mesh.

12. The method according to claim 8, wherein at least one of the polymer flake, the powder, and the pellets is heated by a heated air.

13. The method according to claim 8, further comprising the steps of: separating a portion of the pellets based upon a second pre-determined size; and re-processing the portion of pellets into a powder.

14. The method according to claim 8, further comprising the step of separating a metal from at least one of the polymeric flake and the powder.

15. The method according to claim 8, wherein at least one of the polymer flake, the powder, and the pellet is heated with thermal energy removed from a decontaminated pellet.

16. A pelletizing system comprising:
a pellet mill for compressing a quantity of polymer flake of a predetermined size to produce a pellet; and
a decontamination subsystem for heating at least one of the polymer flake and the pellet to remove contaminants therefrom.

17. The system according to claim 16, wherein the pellet is porous and has a sintered skin.

18. The system according to claim 16, wherein the polymeric flake has a size less than thirty-five Mesh.

19. The system according to claim 16, wherein the decontamination system includes a cooling hopper for removing thermal energy from a decontaminated pellet to be applied to at least one of the polymer flake and the pellet.

20. The system according to claim 16, further comprising a size control device for processing the polymer flake into a pre-determined size.
